(19) United States
(12) Patent Application Publication
(10) Pub. No.: US 2020/0130173 A1
(43) Pub. Date: Apr. 30, 2020

(54) Robot Limb

(71) Applicant: Robert Bosch GmbH, Stuttgart (DE)

(72) Inventors: Achim Neubauer, Sinzheim-Vormberg (DE); Thilo Koeder, Gerlingen (DE); Witold Pieper, Renningen (DE)

(21) Appl. No.: 16/606,999

(22) PCT Filed: Apr. 27, 2018
(86) PCT No.: PCT/EP2018/060839

§ 371 Date: Oct. 21, 2019

(30) Foreign Application Priority Data
May 10, 2017 (DE) 10 2017 207 913.4

(51) Int. Cl. B25J 9/10; B82Y 30/00

(52) U.S. Cl. CPC B25J 9/104; B25J 19/0029; B82Y 30/00; B25J 9/102

(57) ABSTRACT

A robot limb has at least one carbon nanotube wire or conductors with a carbon nanotube-based structure. The wire can function simultaneously as a control cable and a conductor of electrical current.

The present invention relates to a robot limb, for example, a robot arm or a robot foot. Furthermore, the present invention relates to the use of carbon nanotubes or conductors based on carbon nanostructures as a cable pull and simultaneously as an electric power line, in particular in the robot limb.

### PRIOR ART

In actuator elements such as a robot arm, forces for implementing movements are transmitted, for example, via cable pulls. At the same time, electrical lines are laid for the power supply of electrical drives or for signal transmission within the system. The wiring is a part of the moving elements, so that the line weight contributes to the total moved weight. The additional weight also to be moved limits the traversing speed of the robot arm and increases the power consumption per movement.

Slip rings are often used in the signal transmission and energy transmission to moving or rotating elements. Without using slip rings, cables can be damaged due to a lack of flexibility and robustness or the ability of the robot arm to move and rotate is limited. To enable an arbitrary number of rotations of an entire robot, for example, slip rings have to be used for power transmission and signal line transmission in robot joints.

### SUMMARY OF THE INVENTION

A robot limb is understood as moving parts of a robot such as arms of moving or stationary robots and legs of moving robots. A robot foot, which does not enable locomotion but rotation of a robot, is also understood as a robot limb.

The robot limb comprises at least one wire made of carbon nanotubes (CNT) or made of conductors based on carbon nanostructures, for example, graphene-based wires. This unifies good electrical conductivity at low weight with extremely high mechanical strength. The reduction of the moved weight in relation to a conventional robot limb enables the reduction of the drive powers of the motors also to be moved and thus the reduction in size thereof. As a result, traversing speeds can be significantly elevated and the range of the limbs can be increased accordingly. Because of the lower mass inertia, deceleration and acceleration procedures during movements can be shortened and a robot can carry out a larger number of operations using the robot limb which comprises a wire made of carbon nanotubes in the same time as using a conventional robot limb. At the same time, robot control units and control cabinets also become lighter and can be carried along more easily by the robot. This is advantageous in particular for nonstationary or humanoid robots.

It is preferable for all electrical conductors of the robot limb, for example, power supply lines and signal lines, to comprise carbon nanotubes or conductors based on carbon nanostructures. Moreover, all components of the robot limb particularly preferably consist of materials which have a temperature resistance of at least 600° C., very particularly preferably of at least 700° C. Carbon nanotubes and conductors based on carbon nanostructures have a significantly higher temperature resistance than conventional conductors, for example, copper-based or aluminum-based conductors. The robot limb can thus still work even at temperatures in the range of greater than 600° C. or even greater than 700° C. It does not already suffer from massively increasing line resistances and thus increasing power consumption at temperatures from 100° C., like conventional robot limbs, since the electrical resistance of carbon nanotubes and conductors based on carbon nanostructures hardly increases with the temperature. If one also forms the windings and components of the actuators using carbon nanotubes, hot room robot limbs may be conceived which can operate energy-efficiently over a longer term at high temperatures without having to also provide enormous cooling expenditures.

Furthermore, it is preferable for the robot limb to be configured for use in a liquid or a liquid-gas mixture, and for all components of the robot limb to be chemically resistant to the liquid or the liquid-gas mixture. The high chemical resistance of carbon nanotubes or conductors based on carbon nanostructures offers advantages for robot limbs which are used in liquids or liquid-gas mixtures, which are not suitable for copper-based or aluminum-based conductors for chemical reasons or require additional protective layers and cannot have slip contacts. In this case, for example, these are limbs for pipeline checking robots for the petroleum/natural gas and fuel industry or for the chemical/pharmaceutical industry.

The at least one wire is preferably configured to function simultaneously as a cable pull and as an electrical power line. While these two functions have to be fulfilled by separate elements in conventional robot arms, because conventional power cables would not withstand the tensile stresses in a robot limb, the high tensile strength of carbon nanotubes enables these two functions to be unified in the wire of the robot limb. They can thus be implemented compactly and having low weight. In the function as an electrical power line, the power loss is reduced and the number of the load changes is increased, since a flexible wire made of carbon nanotubes has a higher torsion and bending capacity than a metallic conductor and also no aging at bending points. The overall line length can be reduced, since due to the bending slackness of carbon nanotubes, a lesser length reserve has to be provided at joints. Moreover, because of the lower coefficient of thermal expansion of the carbon nanotubes, a lesser length reserve also has to be provided because of temperature variations.

In the function of the wire as a cable pull, it is preferably fastened on a drive roller of the robot limb. The fastening can be performed in particular by knotting. During a movement of the drive roller, the wire is wound and unwound and thus moves the robot limb. The fastening on the drive roller can function simultaneously as the electrical contact of the wire in this case. For this purpose, it does not have electrical insulation in the contact with the drive roller. With suitable guiding of the wire, it can even be embodied completely without electrical insulation.

In one embodiment of the robot limb, the at least one wire is configured to function as an electrical power supply. In this manner, an actuator of the robot limb can be supplied with electric power.

In another embodiment of the robot limb, the at least one wire is configured to function as an electrical signal line. In this manner, signals of a sensor can be conducted via the wire.

It is furthermore preferable for the at least one wire to be configured to be twisted by a rotational movement of the robot limb. The fact is utilized in this case that carbon nanotubes permit a significantly higher degree of twisting than copper cables. Only the shortening of the wire resulting due to the twisting has to be kept in reserve.

If the robot limb comprises multiple wires made of carbon nanotubes extending in parallel, they may be arranged so that they can be twisted with one another by a rotational movement of the robot limb.

If the robot limb is embodied as rotatable, it can be embodied using at least one wire made of carbon nanotubes so that it does not comprise a slip disk and nonetheless permits a multiple rotation. It is preferably configured in this case to permit a rotation of up to 720°, particularly preferably up to 1080°, so that multiple revolutions required in operation of the robot limb can be implemented without having to provide a slip disk as an additional component for this purpose.

If the robot limb requires multiple wires extending in parallel made of carbon nanotubes, for example, to fulfill multiple functions of the power and signal line, it is preferable for the wires to be embodied as a flat band cable. In this case, each wire has electrical insulation in relation to the other wires of the flat band cable. All wires are enclosed by a further common electrical insulation.

A particularly high number of wires made of carbon nanotubes can be used in an extremely constricted space if the flat band cable comprises multiple flat band cables contained therein, which are enclosed by a common electrical insulation.

The use of a wire made of carbon nanotubes as a cable pull and simultaneously as an electrical power line can occur not only in the robot limb. This use is also conceivable in other fields of actuators.

### BRIEF DESCRIPTION OF THE DRAWINGS

Exemplary embodiments of the invention are illustrated in the drawings and are explained in greater detail in the following description.

FIG. 1 shows a transparent isometric illustration of a robot arm according to one exemplary embodiment of the invention.

FIG. 2 shows a transparent isometric illustration of a robot arm according to another exemplary embodiment of the invention.

FIG. 3a shows a schematic sectional illustration of a flat band cable which is used in the robot arm according to FIG. 2.

FIG. 3b shows a schematic sectional illustration of another flat band cable which is used in the robot arm according to FIG. 2.

FIG. 4 shows a side view in partial section of a robot arm according to yet another exemplary embodiment of the invention.

FIG. 5a shows a side view in section of a robot foot according to one exemplary embodiment of the invention.

FIG. 5b shows the robot foot from FIG. 5a after a rotation by 720°.

### EXEMPLARY EMBODIMENTS OF THE INVENTION

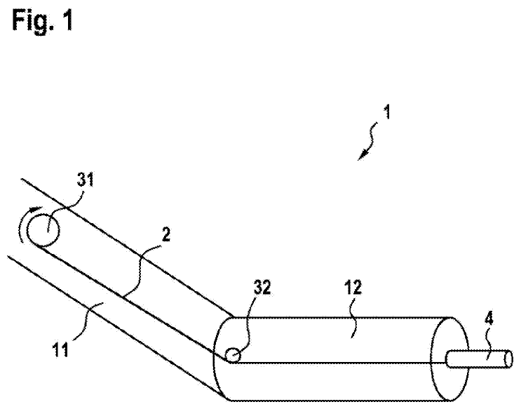

A robot limb 1 according to a first exemplary embodiment of the invention is shown in FIG. 1. It is embodied as a robot arm having an upper arm 11 and a lower arm 12. A drive roller 31 is arranged in the upper arm 11 at an end of the upper arm 11 facing away from the lower arm 12, i.e., in the shoulder region. A guide 32 is arranged in the joint region which connects the upper arm 11 to the lower arm 12. A wire 2 made of carbon nanotubes is knotted to the drive roller 31. It runs via the guide 32 up to the end of the lower arm 12. It is mechanically fastened there and electrically connected to a sensor 4. The wire 2 does not have electrical insulation. The robot arm can be bent by rotating the drive roller 31. Electrical signals of the sensor 4 flow through the wire to the drive roller 31 and can be relayed via this wire.

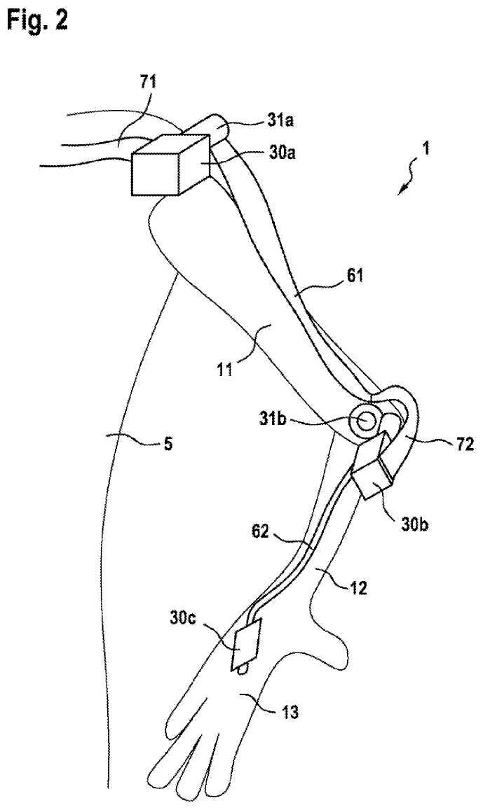

In a second exemplary embodiment of the robot limb 1, which is shown in FIG. 2, it is embodied as an arm of a humanoid robot. This arm comprises an upper arm 11, a lower arm 12, and a hand 13. The upper arm 11 is movably connected to a robot torso 5. A first drive roller 31a is arranged in a shoulder region, which connects the upper arm 11 to the robot torso 5. A second drive roller 31b is arranged in an elbow region, which connects the upper arm 11 to the lower arm 12.

Each drive roller is driven by an electric motor 30a, 30b associated therewith. A further electric motor 30c is arranged in the hand 13 in order to move it. A first flat band cable 61 is fastened in the first drive roller 31a and ends in the elbow region of the robot arm. A second flat band cable 62 is fastened on the second drive roller 30b and ends at the third electric motor 30c. A first electrical terminal 71 connects the first electric motor 30a to a power source in the robot torso 5. A second electrical terminal 72 connects the first flat band cable to the second electric motor 30b. The two flat band cables 61, 62 each contain multiple wires made of carbon nanotubes. They enable the relay of electric power from the power source of the robot torso 5 via the first electrical terminal 71, the first flat band cable 61, and the second electrical terminal 72 to the second electric motor 30b. Moreover, electric power can be relayed from the second electric motor 30b via the second flat band cable 62 to the third electric motor 30c. Wires in the flat band cables 61, 62 which are not required for conducting energy can transmit control signals to the second electric motor 30b and the third electric motor 30c as signal lines. Moreover, they can conduct signals of sensors (not shown) in the robot arm back into an electronic control unit in the robot torso 5.

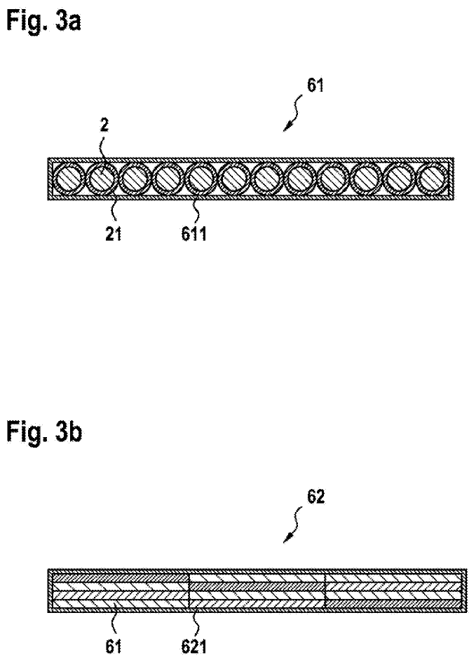

FIG. 3a shows how multiple wires 2 made of carbon nanotubes are each enclosed by an electrical insulation 21 to insulate them from one another. They are arranged adjacent to one another and are enclosed by a further common electrical insulation 611. They thus result jointly in a flat band cable which can be used as the first flat band cable 61 in the second exemplary embodiment of the invention.

Multiple such first flat band cables 61 can be enclosed by a further common insulation 621 and thus be combined to form a larger flat band cable. This is shown in FIG. 3b and can be used, for example, as a second flat band cable 62 in the second exemplary embodiment.

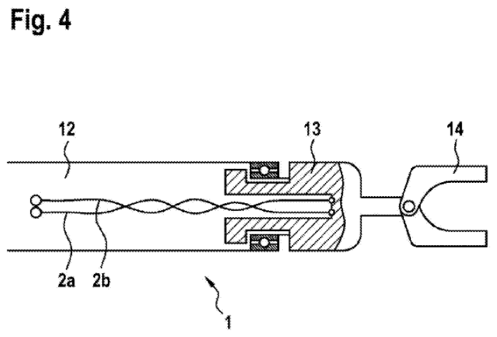

A robot limb 1 according to a third exemplary embodiment of the invention is illustrated in FIG. 4. It is embodied as a robot arm, the lower arm 12 of which is connected to a hand 13, which ends in a gripper 14. The hand 13 is embodied as rotatable in relation to the lower arm 12 via a mount. Two wires 2a, 2b made of carbon nanotubes extend in parallel through the lower arm 12 and into the hand 13, so that they can function as an electrical connection for the gripper 14. As shown in FIG. 4, the wires 2a, 2b can be twisted around one another during a rotation of the hand 13. This enables a rotation of the hand 13 by up to 1080°. A corresponding length reserve of the wires 2a, 2b is provided for this purpose.

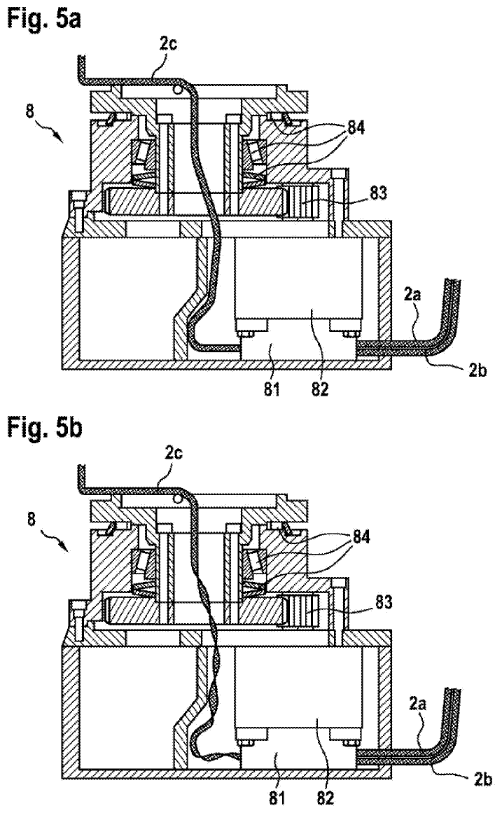

A fourth exemplary embodiment of a robot limb 8 in the form of a robot foot is illustrated in FIG. 5a. The robot foot comprises an electronic control unit 81, which controls an electric motor 82. This motor is connected to a spur gear unit 83. A part of the robot foot embodied as rotatable by means of a bearing system 84 can be rotated by up to 1080° via this gear unit. Two wires 2a, 2b made of carbon nanotubes are connected from outside the robot foot to the electronic control unit 81 in order to transmit control signals and to supply the control unit, the electric motor 82, and further robot components with electric power. To transmit control signals and electric power farther into the robot, a third wire 2c extends through the robot foot and further into a part (not shown) of the robot. The illustration in FIG. 5a shows the length reserve of this third wire 2c before a rotation of the robot foot. FIG. 5b shows a shortening of this third wire 2c by twisting during a rotation of the robot foot by 720°. However, a further length reserve is still always provided for a further rotation of the robot foot.

All above-described exemplary embodiments of the robot limb can be embodied so that all electrical lines of the robot limb also exclusively consist of carbon nanotubes within the actuators. In a fifth exemplary embodiment, all mechanical components are moreover embodied in a high-temperature-resistant material, which enables the operation as a high-temperature robot limb even at temperatures of up to 800° C. In a sixth exemplary embodiment, all mechanical components are embodied as resistant to a liquid-gas mixture. This robot limb is provided for use in the natural gas industry.

1. A robot limb comprising:
at least one wire comprising carbon nanotubes or conductors based on carbon nanostructures.

2. The robot limb as claimed in claim 1, wherein the at least one wire is configured to function simultaneously as a cable pull and as an electrical power line.

3. The robot limb as claimed in claim 2, further comprising:
a drive roller,
wherein the at least one wire is fastened on the drive roller.

4. The robot limb as claimed in claim 1, wherein the at least one wire is configured to function as an electrical power supply.

5. The robot limb as claimed in claim 1, wherein the at least one wire is configured to function as an electrical signal line.

6. The robot limb as claimed in claim 1, wherein the at least one wire is configured to be twisted by a rotational movement of the robot limb.

7. The robot limb as claimed in claim 6, wherein the at least one wire comprises multiple wires made of carbon nanotubes or conductors based on carbon nanostructures, and the multiple wires are configured to be twisted with one another by a rotational movement of the robot limb.

8. The robot limb as claimed in claim 1, wherein the robot limb is rotatable and does not comprise a slip disk.

9. The robot limb as claimed in claim 1, wherein:
the at least one comprises multiple wires made of carbon nanotubes or conductors based on carbon nanostructures, and the multiple wires are configured as a first flat band cable, and
each wire of the multiple wires comprises electrical insulation in relation to the other wires of the multiple wires in of the first flat band cable, and all wires of the first flat band cable are enclosed by a first common electrical insulation.

10. The robot limb as claimed in claim 9, wherein the first flat band cable comprises multiple second flat band cables contained in the first flat band cable, the multiple second flat band cables being enclosed by a second common electrical insulation.

11. The robot limb as claimed in claim 1, wherein all electrical conductors of the robot limb comprise carbon nanotubes or conductors based on carbon nanostructures.

12. The robot limb as claimed in claim 11, wherein all components of the robot limb consist of materials which have a temperature resistance of at least 600° C.

13. The robot limb as claimed in claim 11, wherein the robot limb is configured for use in a liquid or a liquid-gas mixture, and all components of the robot limb are chemically resistant to the liquid or the liquid-gas mixture.

14. A method of using a wire comprising:
using the wire, which comprises carbon nanotubes or conductors based on carbon nanostructures, as a cable pull to move a robot limb; and
simultaneously using the wire as an electrical power line to transmit electrical power.
